(19) United States
(12) Patent Application Publication
(10) Pub. No.: US 2013/0162112 A1
(43) Pub. Date: Jun. 27, 2013

(54) Motor-Gear Unit

(71) Applicants: Florian Loefel, Taufkirchen (DE); Andreas Felsl, Biel (CH)

(72) Inventors: Florian Loefel, Taufkirchen (DE); Andreas Felsl, Biel (CH)

(73) Assignee: B-LABS AG, Biel / Bienne (CH)

(21) Appl. No.: 13/642,452

(22) PCT Filed: Apr. 20, 2011
(86) PCT No.: PCT/EP2011/056343

§ 371 Date: Mar. 1, 2013

(30) Foreign Application Priority Data
Apr. 20, 2010 (DE) 10 2010 017 829.2

(51) Int. Cl. H02K 5/04; H02K 7/116; H02K 11/00

(52) U.S. Cl. CPC H02K 5/04; H02K 11/0042; H02K 7/116
USPC 310/68 B; 310/91; 310/83

(57) ABSTRACT

What is disclosed is a motor/transmission unit for a bicycle which is directly fastened or flange-mounted to a bottom bracket housing, in particular a standard bottom bracket housing. The standard bottom bracket housing is arranged between the motor/transmission unit and a chain ring. A part—in particular casing—of the motor/transmission unit which is integrally connected to the frame may be fastened or flange-mounted to the standard bottom bracket housing in accordance with the International Standard Chain Guide Mount (ISCG).

The invention relates to a motor/transmission unit for a bicycle in accordance with the preamble of claim 1 and a drive unit of a bicycle.

As regards fastening of such motor/transmission units, various approaches are known,

DE 20 2008 001 881 U1 shows an auxiliary drive for a bicycle where a motor and a transmission are fastened separately of each other in different locations of the frame.

DE 697 29 611 T2 shows an auxiliary drive for a bicycle where a bottom bracket bearing is arranged in a casing together with a motor and a transmission. Such a motor/transmission unit can not be fastened to a previously existing bottom bracket bearing of the corresponding bicycle; rather, the bottom bracket bearing must be manufactured or assembled and fastened to the frame of the bicycle together with the motor/transmission unit, This drawback particularly exists when a bicycle having a bottom bracket bearing already mounted is being retrofitted.

In view of the above, the invention is based on the object of providing a motor/transmission unit wherein particularly simple mounting on a bicycle or on the standard parts thereof is possible.

This object is achieved through a motor/transmission unit according to claim 1 or a drive unit for a bicycle according to claim 25.

The motor/transmission unit of the invention is adapted for fastening—preferably direct fastening—to a bottom bracket housing that is fixed to the frame, in particular a standard bottom bracket housing of a bicycle. Here the bottom bracket housing is disposed between the motor/transmission unit and a chain ring. Assembling or retrofitting the motor/transmission unit on a bicycle comprising a bottom bracket housing, in particular a standard bottom bracket housing, accordingly is possible without the latter having to be modified or replaced. It is an additional advantage that no further fastening or reception points for the motor/transmission unit in accordance with the invention are required on the frame.

The motor/transmission unit of the invention is also adapted for fastening on a side of the bottom bracket housing, in particular of the standard bottom bracket housing of the bicycle facing away from at least one chain ring of a bicycle.

The invention thus preferably relates to standard bottom bracket housing while also accommodating different bottom bracket housings.

Further advantageous aspects of the invention are described in the appended claims.

It is preferred if the motor/transmission unit is arranged to the left and the chain ring to the right of the bottom bracket housing when viewed in the running direction of the bicycle.

In a preferred development, the motor/transmission unit is fastened or flange-mounted to the bottom bracket housing via its casing.

In a preferred development, the motor/transmission unit is adapted for fastening to the standard bottom bracket housing in accordance with the meanwhile widely distributed International Standard Chain Guide Mount (ISCG).

In a preferred manner the motor of the unit in accordance with the invention is an electric motor which does not cause any emissions on the bicycle and generates a low noise level.

The electric motor may be an external rotor motor whose rotor encompasses a stator. Hereby it is possible to generate a comparatively high torque. Alternatively, the electric motor may be an internal rotor motor whose stator encompasses a rotor. This allows to realize comparatively good heat dissipation.

The motor of the unit in accordance with the invention may be an electronically commutated, brushless, three-phase synchronous motor.

The motor of the unit in accordance with the invention may also be a disc motor of a particularly flat design or a permanent magnet synchronous motor (PMSM).

A preferred development of the motor/transmission unit of the invention comprises a torque sensor for detecting a torque of a crankshaft adapted to be driven by a rider and/or by the motor of the unit in accordance with the invention

In a preferred manner a motor torque may be transmitted by the motor of the unit in accordance with the invention to the crankshaft in dependence on the torques determined by the torque sensor. This motor torque may be auxiliar or may solely be acting on the crankshaft.

A particularly finely controlled supplementation or addition of motor torque to the torque applied by the rider is possible if the motor torque can also be controlled during one rotation of the crankshaft in dependence on its torque applied by the rider. This allows to equalize fluctuations or systemic irregularities of the torque applied by the rider.

A particularly finely controlled supplementation or addition of motor torque to the torque applied by the rider is also possible if the motor torque can be controlled in dependence on a rotary angle of the crankshaft. This allows to equalize systemic irregularities that are due to the different efficiencies of the pedal cranks.

As the rotational speed of the electric motor usually is higher than that of the crankshaft of the bicycle, it is preferred if the transmission is a reduction gear.

In a first preferred variant the reduction gear is a cycloid gear.

In order to compensate for eccentric masses and produce even running, it is preferred if the cycloid gear comprises two cycloidal discs offset from one another and correspondingly two eccentrics offset from one another.

In a particularly preferred development of the cycloid gear, its pin wheel gearing is formed on the ring gear and fastened to the casing via the ring gear and non-rotating, whereas several bolts of the cycloid gear may be driven via at least one cycloidal disc.

In another particularly preferred development of the cycloid gear the bolts thereof are fastened to the casing and non-rotating, whereas the ring gear is adapted to be driven via its pin wheel gearing and via the at least one cycloidal disc.

In a second preferred variant the reduction gear is a one-stage or multi-stage planetary gear.

In a third preferred variant the reduction gear is a harmonic drive gear, in particular an ellipto-centric gearing or strain wave gear.

It is preferred if the reduction gear has a speed reducing ratio of at least 3/1.

In a preferred manner a free-wheel of the crankshaft relative to the motor of the unit in accordance with the invention, or a clutch—preferably an automatically activated clutch—is provided between the crankshaft and the motor, so that the rider may run or drive without assistance and without simultaneously having to rotate the unit.

In a preferred manner a bottom bracket bearing is integrated in or on the motor/transmission unit of the invention.

In a second preferred development the standard bottom bracket housing may correspond to the International Standard for Bottom Bracket Shells (BB30). In this case bearing shells may be omitted.

The drive unit in accordance with the invention is intended for a bicycle and comprises a bottom bracket housing, in particular a standard bottom bracket housing. On a first side of the bottom bracket housing a motor/transmission unit as described in the foregoing is fastened, while on a second side of the bottom bracket housing facing the first side, one or several chain rings are arranged. This allows mounting or retrofitting of the motor/transmission unit on a bicycle having a bottom bracket housing, in particular a standard bottom bracket housing, without the latter having to be modified or replaced, it is a further advantage that additional fastening or reception points for the motor/transmission unit in accordance with the invention are not required on the frame of the bicycle.

In a preferred manner the invention thus concerns standard bottom bracket housings while, on the other hand, also covering different bottom bracket housings.

In the following, various practical examples of the invention shall be described in detail by making reference to the drawings of the figures, wherein:

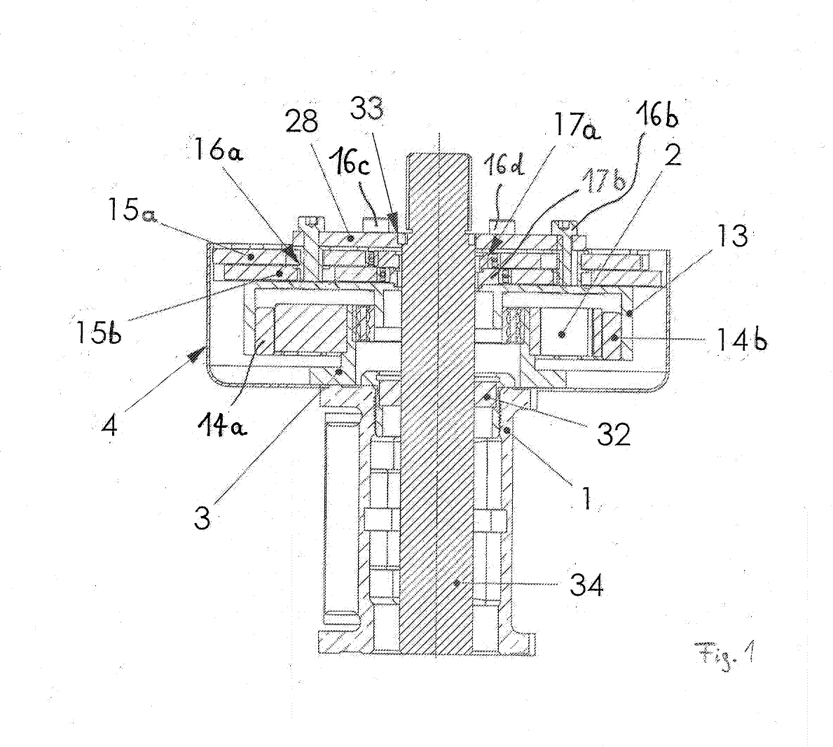

FIG. 1 shows a first practical example of a motor/transmission unit according to the invention in a sectional representation.

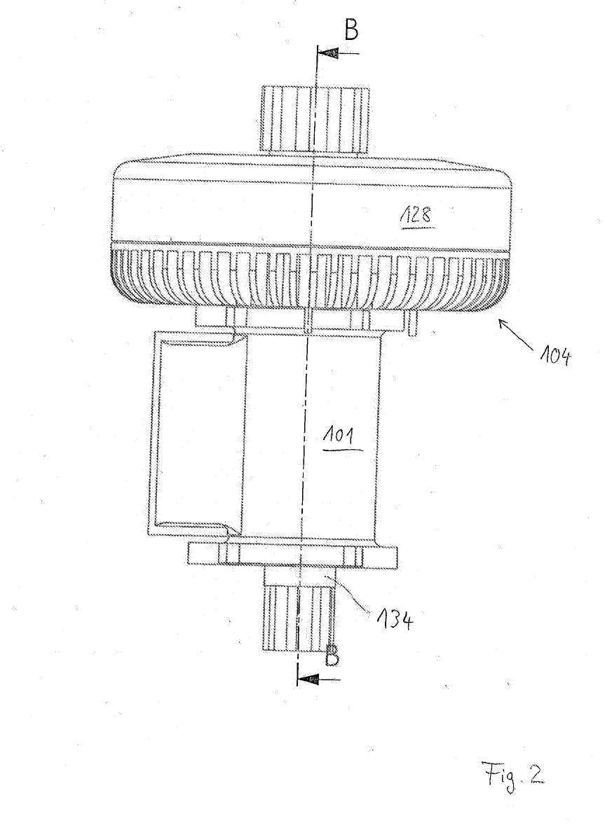

FIG. 2 shows a view of a second practical example of the motor/transmission unit in accordance with the invention.

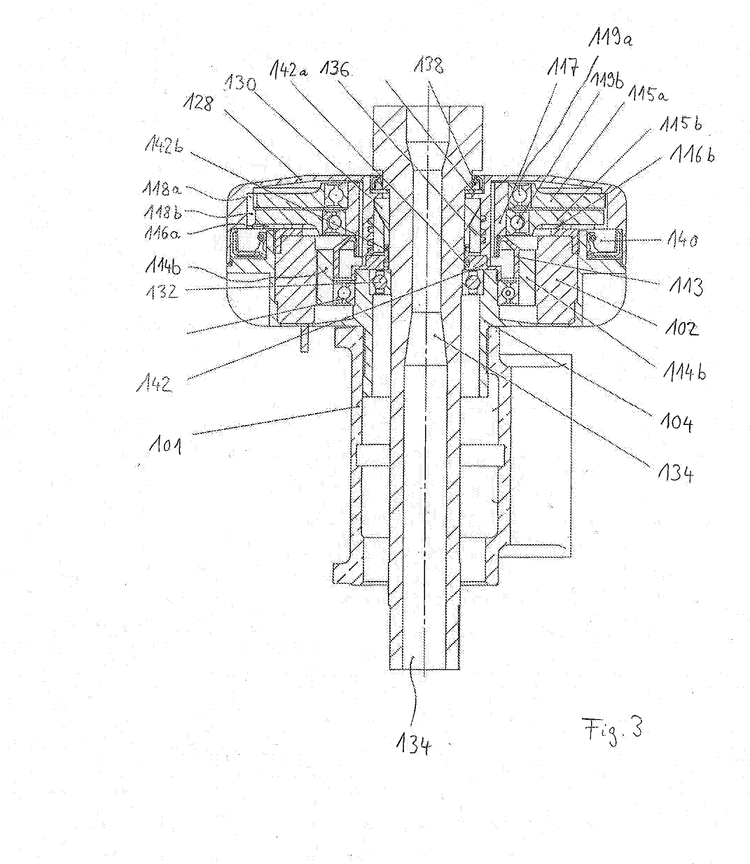

FIG. 3 shows the second practical example of the motor/transmission unit in accordance with the invention in a sectional representation.

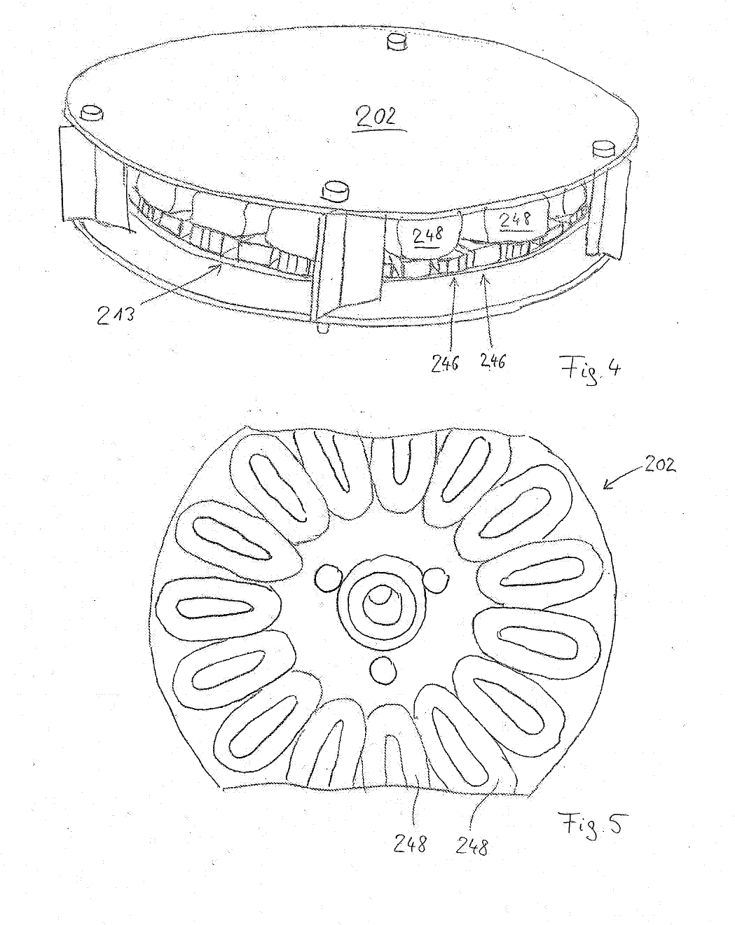

FIG. 4 shows an electric motor of a third practical example of the motor/transmission unit in accordance with the invention in a schematic perspective view.

FIG. 5 shows a detail of a stator of the electric motor according to FIG. 4 in a schematic view.

FIG. 1 shows a first practical example of a motor/transmission unit in accordance with the invention in a sectional representation. Its casing 4 is fastened to a bottom bracket housing 1 via a connection corresponding to the International Standard Chain Guide Mount (ISCG), A crankshaft 34 having pedal cranks fastened to its end portions (not shown) extends through the bottom bracket housing 1 and the casing 4.

The crankshaft 34 is mounted in the bottom bracket housing 1 via bottom bracket bearings of which only one bottom bracket bearing 32 is shown in the figure.

In the lower area of the casing 4 (in the representation of FIG. 1) an electric motor having the form of an external rotor motor is arranged. On the side of the electric motor facing away from the bottom bracket housing 1 (upper side in FIG. 1) a reduction gear having the form of a cycloid gear is arranged, The electric motor comprises a stator mount 3 which is fastened to the casing 4 or the bottom bracket bearing 1 and which carries a stator 2 having a multiplicity (e.g., 28) of permanent magnets arranged at the outer circumference thereof. Of these permanent magnets only two mutually opposed permanent magnets 14a, 14b are represented in the figure. These are fastened to a rotor 13 which rotates jointly with the permanent magnets 14a, 14b during the operation of the electric motor.

Two eccentric discs or eccentrics 17a, 17b of opposed eccentricity are fastened to the rotor 13. Thus, the upper eccentric 17a (in the representation of Fig. 1) is displaced to the left (in FIG. 1) while the lower eccentric 17b in contrast is displaced to the right. At the outer circumference of each eccentric 17a, 17b a cycloidal disc 15a, 15b encompassing the eccentric 17a, 17b is arranged and mounted on the eccentric 17a, 17b via one respective bearing each. At the outer circumference of the two cycloidal discs 15a, 15b a multiplicity of protrusions and recesses are distributed regularly, so that a regular wave shape is created at the respective outer circumferences of the two cycloidal discs 15a, 15b. At the inner circumference of the casing 4 comparable protrusions and recesses are formed. Here the number of protrusions formed on the cycloidal discs 15a, 15b is less by 1 than the number of recesses formed on the casing 4.

During operation of the first practical example of the motor/transmission unit in accordance with the invention, the two eccentrics 17a, 17b are driven by the electric motor at a comparatively high rotational speed, with the protrusions formed on the outer circumference of the two cycloidal discs 15a, 15b continuously plunging into the recesses formed on the inner circumference of the casing 4. As a result the cycioidal discs 15a, 15b execute a comparatively slow rotation. Several driving pins, only four driving pins 16a-d of which are shown in the figure, are received in corresponding through openings of the cycloidal discs 15a, 15b, with only two of these through openings being shown in the figure. The driving pins 16a-d and the recesses are arranged on a circular line, with the diameters of the driving pins 16a-d being smaller than the diameters of the recesses. The rotation of the cycloidal disc 15a, 15b is thus transmitted via its recesses and via the driving pins 16a-d to a drive member 28 which is non-rotationally connected to the crankshaft 34. The shown double cycloidal disc gear thus realizes a reduction gear which reduces the comparatively high rotational speed of the rotor 13 to the comparatively low rotational speed of the crankshaft 34

The motor/transmission unit in accordance with the invention is arranged largely in rotational symmetry with the crankshaft 34 and fastened to the bottom bracket housing 1 with ISCG reception as described in the foregoing.

FIG. 2 shows a view of a drive unit with a second practical example of the motor/transmission unit in accordance with the invention. A casing 104 of the motor/transmission unit is fastened to a bottom bracket housing 101 via a connection corresponding to the International Standard Chain Guide Mount (ISCG). The casing 104 together with an output cover 128 encapsulates the entire motor/transmission unit. A crankshaft 134 having pedal cranks (not shown) fastened to its end portions (upper and lower in FIG. 2) extends through the bottom bracket housing 101, the casing 104, and the output cover 128.

FIG. 3 shows the drive unit with the second practical example of the motor/transmission unit in accordance with the invention in a sectional representation. The crankshaft 134 is mounted in the bottom bracket housing 101 via two bottom bracket bearings of which only one bottom bracket bearing 132 is shown in the figure.

Inside the casing 104 an electric motor is disposed which has the form of an internal rotor motor. It comprises a stator 102 which is fastened to the casing 104. The electric motor further comprises a rotor 113 having permanent magnets arranged at its outer circumference, of which permanent magnets only two mutually opposed permanent magnets 114a, 114b are represented in FIG. 3.

On the side of the electric motor (upper side in FIG. 3) facing away from the bottom bracket housing 101 a cycloid gear is arranged. Its power output to the crankshaft 134 is effected via the slowly rotating output cover 128, Between the output cover 128 and a radial step of the crankshaft 134 a backing washer is inserted. The output cover 128 is connected to a clutch master 136 via a trapezoidal thread such that the clutch master 136 is placed over a clutch cone 130 when the electric motor is driving in the driving direction. The clutch 103, 136 is released when the electric motor is not driving and is opened actively when the electric motor performs a brief reverse rotation. The clutch cone 130 is connected non-rotationally to the crankshaft 134, Between the clutch master 136 and a non-rotating portion of the casing 104 a rotation reference 142 including two O-rings 142a, 142b is arranged. The rotor 113 is mounted on the portion of the casing 104 via a rotor bearing 144.

Two eccentric discs or eccentrics 117a, 117b of the cycloid gear which are of opposite eccentricity are fastened to the rotor 113, Thus, the upper eccentric 117a is displaced to the right, whereas the lower eccentric 117b in contrast is displaced to the left (each in the representation of FIG. 3). At the outer circumference of each eccentric 117a, 117b a cycloidal disc 115a, 115b encompassing the eccentric 117a, 117b is arranged and mounted on the eccentric 117a, 117b via one respective cycloidal disc bearing 119a, 119b each. Between each cycloidal disc 115a, 115b and the output cover 128 a pin wheel gearing is provided. To this end, a multiplicity of protrusions and recesses are distributed regularly at the outer circumference of the respective cycloidal discs 115a, 115b, so that a regular wave shape is created at the respective outer circumferences of the cycloidal discs 115a, 115b. At the inner circumference of the casing 104 comparable protrusions and recesses are formed. The number of protrusions formed on the cycloidal discs 115a, 115b is less by 1 than the number of recesses formed on the casing 104. Driving pins retained integrally with the housing and non-rotationally on the circumference of the stator 102, only two driving pins 116a, 116b of which are shown in FIG. 3, are received in corresponding through openings of the cycloidal discs 115a, 115b of which only two through openings are shown in FIG. 3. The driving pins 116a, 116b and the recesses are arranged on a circular line, with the diameters of the driving pins 116a, 116b being smaller than the diameters of the recesses.

During operation of the second practical example of the motor/transmission unit in accordance with the invention, the two eccentrics 117a, 117b are driven by the electric motor at a comparatively high rotational speed, with the protrusions formed on the outer circumference of the two cycloidal discs 115a, 115b continuously plunging into the recesses formed on the inner circumference of the casing 104. As a result the output cover 128 is driven by the cycloidal discs 115a, 115b in comparatively slow rotation. It is possible to connect the output cover 128 non-rotationally to the crankshaft 134 via the clutch 130, 136. Thus, in the second practical example, too, the double cycloidal disc gear realizes a reduction gear which reduces the comparatively high rotational speed of the rotor 113 to the comparatively low rotational speed of the crankshaft 134.

While the drive crankshaft 134 via the motor/transmission unit is not activated, a shaft seal ring 138 accommodates a rotational speed difference between the output cover 128 at rest and the rotating crankshaft 134, whereas in the activated state a shaft seal ring 140 seals the casing 104 at rest and the rotating output cover 128 despite the rotational speed difference between these two casing parts.

The second practical example of the motor/transmission unit in accordance with the invention is thus arranged largely in rotational symmetry with the crankshaft 134 and fastened to the bottom bracket housing 101 with ISCG reception as described in the foregoing.

FIG. 4 shows an electric motor of a third practical example of the motor/transmission unit in accordance with the invention in a schematic perspective view. The electric motor is especially space-saving in the axial direction and may be provided instead of the electric motors according to FIG. 1 or according to FIG. 2.

On a disc-shaped rotor 213 a multiplicity of permanent magnets 246, of which only the end faces at the outer circumference of the rotor 213 are visible in FIG. 4, are arranged in a star configuration. At a spacing from the permanent magnets (in FIG. 4 above the permanent magnets 246) a multiplicity of coils 248, of which only the end faces at the outer circumference of a stator 202 integrally fastened to the housing are visible in FIG. 4, are arranged in a star configuration.

FIG. 5 shows a detail of the stator 202 of the electric motor according to FIG. 4 with the multiplicity of coils 248 in a schematic view.

In difference from the shown practical examples, the motor/transmission unit in accordance with the invention may also be provided in a handbike which is driven by the arm power of a handbiker, wherein crank handles are fastened to the end portions of the crankshaft 34.

What is disclosed is a motor/transmission unit for a bicycle which is directly fastened or flange-mounted to a bottom bracket housing, in particular a standard bottom bracket housing. The standard bottom bracket housing is arranged between the motor/transmission unit and a chain ring,

A part—in particular casing—of the motor/transmission unit which is integrally connected to the frame may be fastened or flange-mounted to the standard bottom bracket housing in accordance with the International Standard Chain Guide Mount (ISCG).

### LIST OF REFERENCE SYMBOLS

1; 101 bottom bracket housing
2; 102; 202 stator
3 stator mount
4; 104 casing
13; 113; 213 rotor
14a, 14b; 114a, 114b permanent magnet
15a, 15b; 115a, 115b cycloidal disc
16a, 16b, 16c, 16d; 116a, 116b driving pin
17a, 17b: 117 eccentric
28 drive member
32; 132 bottom bracket bearing
33 detent pawl
34, 134 crankshaft
118a, 118b pin wheel gearing
119a, 119b cycloidal disc bearing
128 output cover
130 clutch cone
136 clutch master
138 shaft seal ring
140 shaft seal ring
142 rotation reference
142a, 142b O-ring
144 rotor bearing
246 permanent magnet
248 coil

1. A motor/transmission unit for a bicycle which is adapted for fastening to a standard bottom bracket housing, characterized in that the standard bottom bracket housing is arranged between the motor/transmission unit and a chain ring.

2. The motor/transmission unit according to claim 1, which is fastened to the standard bottom bracket housing via a casing.

3. The motor/transmission unit according to claim 1, which is adapted for fastening to the standard bottom bracket housing (1; 101) in accordance with the International Standard Chain Guide Mount (ISCG).

4. The motor/transmission unit according to claim 1, the motor of which is an electric motor.

5. The motor/transmission unit according to claim 4, wherein the electric motor is an external rotor motor whose rotor encompasses a stator, or wherein the electric motor is an internal rotor motor whose stator encompasses a rotor.

6. The motor/transmission unit according to claim 1, the motor of which is an electronically commutated, brushless, three-phase synchronous motor.

7. The motor/transmission unit according to claim 1, the motor of which is a disc motor whose rotor (213) is arranged axially next to a stator.

8. The motor/transmission unit according to claim 1, whose motor is a permanent magnet synchronous motor (PMSM).

9. The motor/transmission unit according to claim 1, comprising a torque sensor for detecting a torque of a crankshaft adapted to be driven by a rider and/or by the motor.

10. The motor/transmission unit according to claim 9, wherein a motor torque may be transmitted by the motor to the crankshaft in dependence on the torque.

11. The motor/transmission unit according to claim 10, wherein the motor torque may be controlled during a rotation of the crankshaft.

12. The motor/transmission unit according to claim 10, wherein the motor torque may be controlled in dependence on a rotary angle of the crankshaft.

13. The motor/transmission unit according to claim 1, wherein the transmission is a reduction gear.

14. The motor/transmission unit according to claim 13, wherein the reduction gear is a cycloid gear.

15. The motor/transmission unit according to claim 14, wherein the cycloid gear comprises two cycloidal discs offset from one another and two eccentrics offset from one another.

16. The motor/transmission unit according to claim 14, wherein a pin wheel gearing of the cycloid gear is arranged in a ring gear and integrally connected to the housing, and wherein bolts of the cycloid gear may be driven.

17. The motor/transmission unit according to claim 14, wherein bolts of the cycloid gear are integrally connected to the housing, and wherein a ring gear is adapted to be driven via a pin wheel gearing of the cycloid gear.

18. The motor/transmission unit according to claim 13, wherein the reduction gear is a one-stage or multi-stage planetary gear.

19. The motor/transmission unit according to claim 13, wherein the reduction gear is a harmonic drive gear.

20. The motor/transmission unit according to claim 13, wherein the reduction gear has a speed reducing ratio of at least 3/1.

21. The motor/transmission unit according to claim 1, comprising a free-wheel of the crankshaft relative to the motor.

22. The motor/transmission unit according to claim 1, comprising a clutch which is arranged in the flux of force between the motor and the crankshaft.

23. The motor/transmission unit according to claim 1, comprising an integrated bottom bracket bearing.

24. The motor/transmission unit according to claim 1, wherein the standard bottom bracket housing corresponds to the International Standard for Bottom Bracket Shells (BB30).

25. A drive unit for a bicycle comprising a standard bottom bracket housing, on a first side of which a motor/transmission unit in accordance with any one of the preceding claims is fastened, and on a second side of which a chain ring is arranged.
